(19) United States
(12) Patent Application Publication
(10) Pub. No.: US 2024/0146071 A1
(43) Pub. Date: May 2, 2024

(54) ENERGY SYSTEM

(71) Applicant: BOS BALANCE OF STORAGE SYSTEMS AG, Neu-Ulm (DE)

(72) Inventor: Thomas KUENDIGER, Neu-Ulm (DE)

(73) Assignee: BOS BALANCE OF STORAGE SYSTEMS AG, Neu-Ulm (DE)

(21) Appl. No.: 18/564,710

(22) PCT Filed: May 26, 2022
(86) PCT No.: PCT/EP2022/064358

§ 371 Date: Nov. 28, 2023

(30) Foreign Application Priority Data
May 29, 2021 (DE) 10 2021 113 937.6

(51) Int. Cl. H02J 7/00

(52) U.S. Cl. CPC H02J 7/00047; H02J 7/0014; H02J 7/0029; H02J 7/35; H02J 2207/20

(57) ABSTRACT

An energy system includes at least one energy store for storing electric energy, and at least one inverter, the energy system being modularly designed in respect of the energy store and/or the inverter. Also, the use of the energy system when forming a stand-alone power system has particularly low standby losses as a result of the use of an electrically non-isolated DC/AC converter as well as high efficiency especially in the low partial load range. In addition, the energy system can have a use in which energy sources such as PV modules can be connected to the energy system within the protective extra-low voltage, as is often desired in caravans and motorhomes.

The invention relates to an energy system with at least one energy store for storage of electrical energy and at least one inverter.

Electrical energy is to increasing extent obtained from renewable energies, the irregular yields of which signify a growing need for energy stores.

In the important group of electrochemical energy stores there are, apart from customary lead and lithium batteries, also to increasing extent newly developed and/or newly established stores which have very different technical characteristics. These also comprise oxidation-reduction flow batteries and also bidirectionally operating energy converters such as electrolysers and fuel cells with appropriate stores.

In addition, there is a need to store a part of the energy, as well as excesses, in other stores such as thermal stores for hot water preparation, mass storage devices in building air-conditioning or also physically separate electrochemical stores. Added to that are mobile stores such as incorporated in electric vehicles.

In the case of use of one or more stores and an AC mains or renewable energies, there is associated with each store a circuit which during charging of the energy store has the task of transforming the energy from the AC mains or from the renewable energy into the direct voltage present at the store side, as well as, during discharging, of transforming the store-side direct voltage into an AC mains voltage which, when an AC mains is present, is synchronised therewith or in the case of a stand-alone mains is arranged to form a mains.

Many battery inverters are known which can store the energy from renewable energy and an individual store in an existing energy network and can in part also be used, in mains formation, as a stand-alone inverter (off-grid inverter). These circuits have a level of efficiency which is dependent on several operating parameters and which often is acceptable only within relatively tight limits around the typical case of use.

Above all, in the case of use in a stand-alone grid, operation in the lower part-load range and in standby is very frequent. The efficiency of customary converter circuits then very strongly diminishes particularly in these use scenarios.

Such stand-alone grids are in use remotely from public power mains as individual plants, in combination with a minigrid or also increasingly in mobile applications such as in mobile homes or portable equipment, and as emergency power supply in countries/districts with unstable power mains.

In the case of incorporation with a further energy store or further converter this means additional further conversion losses and even greater energy need in standby. Efficiency is further reduced.

The object of the invention is therefore to create an energy system which has good efficiency within a wide range of use.

According to the invention this object is fulfilled by the energy system being of modular construction with respect to energy stores and/or inverters.

By virtue of the modular construction the energy system can be adapted to the respective conditions of use.

In that case it has proved very advantageous if at least one battery store with at least one battery module is provided, wherein the individual battery modules are designed within the limits of protective low voltage.

It is thus ensured that also individual battery modules can be exchanged, used and extended without risk even by unskilled users.

In this connection it is very advantageous if the battery modules of a battery store are connected in series and/or in parallel with one another.

As a result, on the one hand through series connection a higher level of output voltage of the battery store is guaranteed so that in the case of DC/AC conversion a lower transformation ratio is needed, and on the other hand through parallel connection the necessary power is made available.

Moreover, according to an embodiment of the invention it has proved very advantageous if charge equalisation of the individual battery modules of a battery store is provided.

It is ensured by means of this charge equalisation that the individual battery modules are respectively optimally charged and discharged so that wear of the battery modules is minimised.

According to a development of the invention it is also extremely advantageous if a DC/DC converter which can be arranged to be electrically isolated is provided for each battery store or each battery module.

Through series connection of individual battery modules the output voltage of the respective battery store or battery module is adjusted to the desired output voltage and input voltage of the DC/AC converter. By virtue of the electrical isolation by way of the DC/DC converter a freely selectable voltage, usually a protective low voltage, is provided in a potential-free manner. If the DC/DC converter is formed to be bidirectional then the battery modules can also be charged by way of that.

A very advantageous development of the invention is also present if a DC/DC converter is provided, which generates a first system voltage which can be higher or lower than or the same as the voltage of individual or multiple battery modules, wherein the DC/DC converter can have electrical isolation and formed to be bidirectional.

A system voltage which enables optimal operation of the system and also controlled charging and discharging of the further energy stores is made possible by this DC/DC converter. In addition, energy can be exchanged between the battery modules or the system can be charged by a DC generator or the like. A defined and controlled charge equalisation between the battery modules can take place through regulation of the DC/DC converters.

Moreover, in accordance with the invention it is very advantageous if a DC/AC converter is provided which can be of bidirectional form.

The energy system can also be connected by that with an alternating current mains. Three-phase embodiments are conceivable.

According to the invention it is also very advantageous if a plurality of DC/AC and/or DC/DC converters is provided.

These converters can be used alongside one another or also alternatively. The creation of DC and AC mains is thus possible.

According to a further embodiment of the invention it is also very advantageous if the respective converter or the respective converter combination is selected in accordance with the respective operating state of the energy system, wherein that converter or converter combination having the lowest losses can be selected.

On the one hand, power scaling and also loss minimisation can take place by that. The energy system can thus be operated in the optimal range at any time.

According to a development of the invention it has also proved very advantageous if power limitation is provided depending on the respective operating state of the energy system.

Overloading of the individual components is thus prevented.

It is also extremely advantageous if the system is designed so that provided protective devices are preferably selectively triggered.

It is thereby ensured that an effective protection of plant and persons is given. In the event of a fault the power of the system can even be temporarily regulated in such a way that safety devices can be triggered, in other words short-circuit currents are provided, which is necessary particularly in stand-alone operation for triggering of circuitbreakers and fuses. The power limitation is in that case activated with delay, which would otherwise also immediately lead to switching-off of the system.

A further very advantageous development of the invention is also present if an efficient electronic charging system for charging of the battery store is provided, wherein this can also be executed as a simple rectifier circuit with appropriate adaptation of the voltage of the battery store.

It is, for example, conceivable to design the battery store to a voltage closely below mains voltage, i.e. in the case of a 230 volt mains to 150 to 200 volts, so that charging can be realised by way of a simple, even clocked rectifier circuit. The electronic charging system can be integrated in the DC/AC converter. Thus, in the case of an unstable power mains, energy can nevertheless be drawn from the mains whilst the DC/AC converter is used for forming a stable AC output voltage for supply of the consumers.

A further, very advantageous development of the invention is present if the energy system combines different energy sources on AC and/or DC side and/or different energy stores, particularly battery stores with modules of lithium batteries, preferably LiFePO4 batteries, lead batteries, redox flow batteries or other store types.

A plurality of energy sources and a plurality of battery stores can be linked with one another. In addition, it is possible to connect different storage systems with one another, wherein these are also physically separate from one another. Thus, the different characteristics of different storage systems and storage types can be connected to one another in such a way that these operate in optimal manner. Several separately controlled DC/DC converters are usually combined for that purpose. The use of a DC/DC converter which can be constructed as a photovoltaic charge regulator with pulse-width-modulation regulation or maximum power point tracking is conceivable. This is connected in the same DC voltage plane as the inverter, whereby here as well a particularly favourable voltage ratio between photovoltaic voltage and battery voltage can be selected.

According to the invention it has in that case proved very advantageous if the converter modules for each energy source or each energy store are designed, with regard to the characteristics thereof, with respect to, for example, power.

As a result, for example, a first battery store with modules of lithium batteries, particularly LiFePO4 cells, can be provided, whilst a second battery store with a lead battery, the on-board mains of a vehicle or a store with good long-term characteristics, particularly a redox flow battery, is provided. The energy flows in the DC/AC converter to the first store are, in correspondence with the characteristics of the battery store, significantly greater than the energy flows in the DC/DC converter or to the second battery store, which has a particularly positive effect on efficiency and production costs of the components, as well as extends the service life of the individual stores.

According to a further development of the invention it is also very advantageous if the energy sources are electrically isolated by way of the DC/DC converter.

As a result, the desired safety, freedom from potential and the equalisation of energy between battery modules on different voltage planes is ensured. Nevertheless, the DC/AC converter can be constructed in simple and economic manner without electrical isolation, but with higher voltage, through series connection of the battery modules.

According to the invention it is also extremely advantageous if energy distribution between the individual energy sources or energy stores is provided by way of the DC circuit.

Through energy distribution on the DC plane it is not necessary to firstly undertake a DC/AC conversion and a return conversion with the corresponding losses.

Moreover, according to the invention it has proved very advantageous if the DC circuit is so designed with respect to its voltage that the DC/AC converter has only a low transformation ratio with regard to the voltage or does not have to undertake any voltage transformation, but only has to form the alternating voltage.

As a result, unnecessary losses and additional cost due to a 400 volt intermediate circuit in the DC/AC converter are avoided. In addition, this can be constructed economically and in simple mode and manner.

A further advantageous embodiment is also present if the DC converter has only a low transformation ratio with respect to the voltage.

As a result, unnecessary losses are likewise avoided and an economic and simple mode of construction of the converter is made possible by that. A high degree of efficiency is ensured.

The two together, i.e. the combination of several electrically isolated DC/DC converters at the individual battery modules and the series connection of the battery modules for supply of the DC/AC converter, make it possible for energy to be very efficiently converted into 230 volt AC even from a 12 volt/24 volt DC system, particularly DC on-board mains of vehicles.

According to a further embodiment of the invention it is also extremely advantageous if the circuits of the converters are constructed in such a way that the negative poles of the direct voltage systems correspond with the neutral conductor of the alternating voltage systems and thus a common reference potential is present.

By virtue of the common reference potential, undesired problems due to different potentials can be avoided.

Moreover, it is very advantageous if two or more storage systems are arranged antisymmetrically and if each of the two storage systems has associated therewith a DC/AC converter which respectively generates a half wave of the alternating voltage and if the neutral conductor of the alternating voltage system has a common reference potential with the centre of the storage modules.

As a result the outlay on DC/AC conversion can again be significantly reduced. A half wave can be directly formed from each battery store by a simple buck boost converter without the negative half wave having to be realised by a change in potential of the DC side or a more complicated circuit. This is particularly useful when in the negative half wave the maximum current of the battery also has to be directly provided as a short-circuit current on the AC side without having to be firstly converted in a coil or electronic circuit. The centre tap between the storage modules is then the reference potential for the neutral conductor of the alternating voltage system.

According to the invention it is extremely advantageous if storage systems with different characteristics, particularly long-term storage systems and short-term storage systems, are combined with one another, in which case it can be provided that only the AC terminals and the DC terminals, which are electrically separated by the DC/DC converter, can be tapped without making available direct access to the storage modules.

The advantages of the two storage systems can thus be combined with one another. The storage systems can in that case also be arranged to be physically separate from one another. The terminals of the storage modules are protected so that undesired effects or even harm to persons or damage to the storage modules or the system cannot occur. Lithium batteries, in particular, are to be protected here. An interaction with the on-board mains of vehicles is conceivable. In addition, the components, particularly the DC/DC converter, can be dimensioned to be significantly smaller and more favourably than the DC/AC converter.

A very advantageous development of the invention is also present if several autonomous energy systems are combined at least temporarily to form an overall system, wherein the energy systems can also be arranged to be physically separate from one another.

A flexible system can thus be created according to need and energy availability.

According to the invention it is also extremely advantageous if a control unit is provided for each energy system or also in superordinate manner over several energy systems.

This control unit ensures correct and efficient operation of the individual systems and also several energy systems in compound. The control unit can in that case be provided as a separate unit or, however, also be integrated in the respective energy system, the converter unit or a battery store.

A very advantageous use is present if the energy system in the formation of a stand-alone grid by the DC/AC converter, which is not electrically isolated, has particularly low standby losses and a high level of efficiency particularly in the lower part-load range.

Unnecessary losses are thereby avoided. The formation of an efficient stand-alone grid, for example as a pure stand-alone grid or also in the case of fluctuating and unstable power supplies, is made possible by that.

A further use, which is very advantageous in accordance with the invention, of the energy system according to the invention is also present if the energy system within protective low voltage enables integration of energy sources such as, for example, photovoltaic modules as is often desired in the field of caravans and mobile homes.

Possibilities are thereby created, particularly in these areas, but also in all other cases of use, of feeding energy from low voltage sources into the energy system. It is in that case also conceivable for the feed to also take place at different voltage levels which are provided by corresponding connection of the battery modules together. The electrical separation between battery module and voltage level made available is important in this case.

The invention is clarified in the following by way of several embodiments, in which:

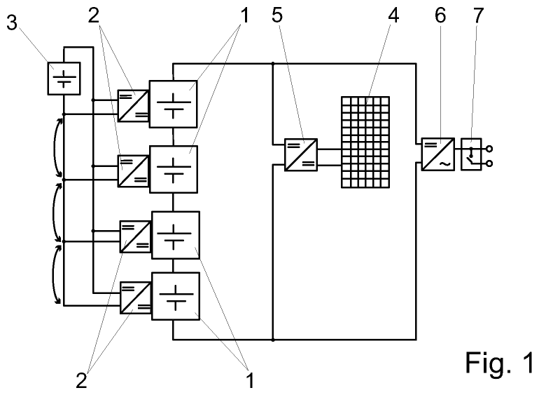

FIG. 1 shows a schematic illustration of an energy system according to the invention,

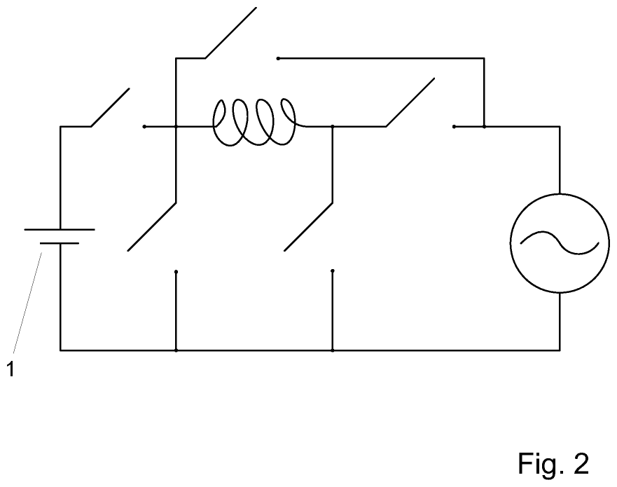

FIG. 2 shows a schematic illustration of the circuit of an innovative inverter,

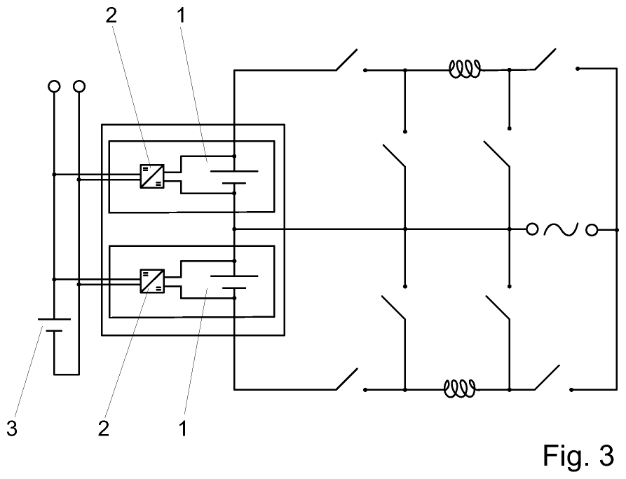

FIG. 3 shows a schematic illustration of the circuit of two inverters which, with fixed centre potential, generate an alternating voltage,

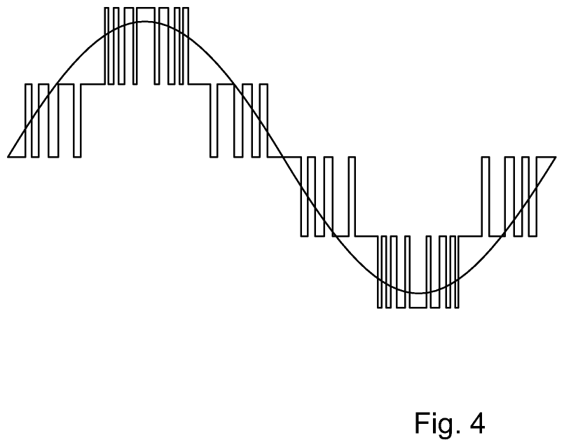

FIG. 4 shows a schematic illustration of a generated sine curve having a clocked and a non-clocked component, and

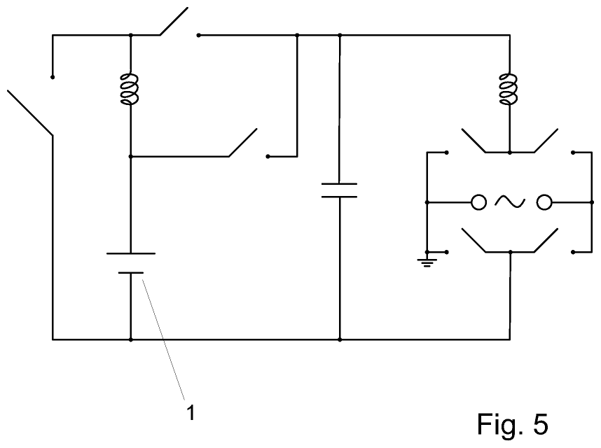

FIG. 5 shows a schematic illustration of the circuit of a simple two-stage DC/AC converter.

The invention relates to an improved energy storage system for storage of electrical energy and to an improved circuit arrangement for integration of one or more energy stores and energy sources, such as a photovoltaic system, in an AC mains.

Electrical energy is obtained to increasing extent from renewable energies, the irregular yields of which mean a growing need for energy stores.

In the important group of electrochemical energy stores there are, apart from customary lead and lithium batteries, also increasingly newly developed and/or newly established stores which have very different technical characteristics. Belonging to these are, in particular, redox flow batteries and fuel cells.

In addition, there is a need to store a part of the energy, as well as excesses, in other stores such as thermal stores for hot water preparation, bulk stores in building air-conditioning or also physically separate electrochemical stores. Added to that are mobile stores such as incorporated in electric vehicles.

In the case of use of one or more stores and an AC mains or renewable energies there is associated with each store a circuit which has the task during charging of the energy store of transforming the energy from the AC mains or from the renewable energy into the direct voltage present at the store side, as well as, in the case of discharging, of transforming the store-side direct voltage into an AC mains voltage which, if an AC mains is present, is synchronised therewith, or in the case of a stand-alone grid is arranged to form a mains.

Many battery inverters are known which can supply energy from renewable energy and an individual store to an existing energy mains and in part can also be used, for mains formation, as a stand-alone inverter (off-grid inverter). These circuits have an efficiency which is dependent on several operating parameters and which often is acceptable only within relatively close confines around the typical operational case.

Above all, in the case of use in a stand-alone grid the operation in the lower part-load range and in standby is very frequent. The efficiency of customary converter circuits is then very strongly reduced particularly in these use scenarios.

Such stand-alone grids are in use remotely from public power mains as individual plants, in combination with a minigrid or also increasingly in mobile applications such as mobile homes or portable equipment, as well as an emergency power supply in countries/districts with unstable power mains.

In a case of incorporation of a further energy store or further converter this means additional further conversion losses and even greater need for energy in standby. Efficiency is further reduced.

In order that the inverter can charge the battery from the AC mains and feed energy into the AC mains the circuit of the inverter is formed to be bidirectional.

According to an embodiment the battery voltage of the first battery store is selected to be similar to or somewhat below the effective value of the mains voltage such that the battery store can be charged by a simple rectifier even from very unreliable mains with strongly fluctuating voltage and frequency or from motor-driven generators without automatic voltage regulation, whereas the more complicated inverter circuit is needed only for feeding into an AC mains. Losses are thereby minimised.

The selection of the battery voltage of the first battery shall on the one hand be so low that it can be readily formed from a variable number of battery modules in the region of protective low voltage, but on the other hand as high as possible so that the conversion losses to AC remain as small as possible and components on the DC side can be dimensioned with respect to a lowest possible current.

For example, all components can be designed to a current of 20 amps, which then allows an inverter power of 3 . . . 5 kilovolt amps AC per inverter module. In the case of a three-phase layout, i.e. an inverter equipped with three power sections, a power of 10 kilovolt amps in three-phase form then results, wherein a maximum unbalanced load of 5 kilovolt amps on a phase is made possible.

In addition, in the case of stand-alone grids special attention is to be given to possible fault cases. Low-frequency rectifiers can in the case of appropriate design also provide a short-circuit current and are simple to construct. However, these are disadvantageous with respect to the form of construction and efficiency by comparison with high-frequency inverters. Moreover, a high level of outlay on material is necessary. The potential for reducing costs is thus significantly limited.

If use is now made of a 400 volt DC intermediate circuit a sine can be formed very simply without a further step-up device, whilst in the case of use of the energy system in a large distribution mains sufficient energy is available to provide large peak powers during starting of a motor or charging of larger capacitors in electronic equipment. In addition, in the case of fault—wherein here primarily the fault case of a short-circuit is considered—these can trigger a safety device due to the large peak power.

In the case of small rectifiers in stand-alone operation particular attention has to be given to whether the current, which is needed for triggering a safety device, in the event of a fault can be made available temporarily. Ideally, in the case of safety devices selectively connected in series, the smallest safety device in the vicinity of the fault location shall be triggered, instead of the entire inverter, and thus switch-off of the entire stand-alone mains due to excess current.

In the case of use of several converters in a system, the respective most suitable converter can be selected. Thus, for example, circuits with a high clock rate with an electronic power system on the basis of silicon carbide (SiC) or gallium nitride (GaN) can be combined with circuits which enable, for example, greater short-circuit currents or lower standby need for energy.

Equally, it is possible for very simple circuits such as bridge rectifiers or trapezium inverter circuits to be combined with a high-frequency circuit and thus departures from the sinusoid of the other converter to be smoothed.

In this connection, by means of a superordinate control on the basis of different parameters such as, for example, the charge state of the first or further batteries, the anticipated gains from regenerative energies or the extracted power, it is possible to select the optimal operating mode with respect to other parameters such as system efficiency or supply reliability. This superordinate control can be either separately realised or integrated in one of the components, particularly in the inverter module or one of the inverter modules.

The energy storage system is designed so that in the typical case of use, particularly in the lower part-load range, the best efficiency is achieved and in standby with respect to AC mains formation the energy is provided from one or more energy stores with lowest possible losses. This case of use usually arises with stand-alone grids. In addition, the energy storage system has good characteristics with respect to operation of a stand-alone grid. A simple installation and modularity with low production costs is equally provided.

In many cases of use, particularly in the instance of use in caravans and trucks with a 12 volt or 24 volt on-board mains, not only a 230 volt AC mains, but also a DC mains are operated in the voltage range of protective low voltage.

Bidirectional energy flows are provided here.

For that purpose it is advantageous to select the power which can be transferred in the electrically coupled DC/AC converter to be significantly greater than the power of an electrically isolated DC/DC converter. As a result, there are advantages in the DC/AC converter not only with constructional size and costs, but also with efficiency.

The electrically isolated DC/DC converter is then primarily provided for operation of a superordinate control, the DC loads, further batteries and a generator (alternator) and only has to transfer a lower level of power.

If an electrically isolated DC/DC converter is associated with each battery module an active charge equalisation (balancing) between the individual battery modules is thereby made possible. Moreover, the transformation ratio between, for example, a 12 volt on-board mains and 48 volt battery modules at 1:4 is significantly lower than if the energy had to be converted from a series circuit of the 48 volt modules with a larger transformation ratio.

The following advantages, above all, thereby arise:
The electrically isolated DC/DC converter has better efficiency,
can be dimensioned to be smaller and thus more economic,
enables balancing between individual battery packs and
can be operated on both sides within protective low voltage.

In order that the desired modularity and a sufficient cost degression in production is given the inverter is preferably accommodated in a standardised housing with control means and terminals, as well as, if required, with up to three modular power sections.

The power of a power section lies in the range of 3 to 5 kilowatts. The overall power can be scaled through use of several parallel power sections. In order to prevent overloading, limitation of the power, for example, according to the number of battery modules is also conceivable. Thus, it is conceivable that on the DC side everything is always designed to a maximum of 20 amps, but the power is limited by the use of different system voltages.

It is also conceivable that a housing, which is optimised with respect to a small volume and in which only a power section for single-phase use can be inserted, is used for lower powers such as, for example, stand-alone grids for simple households, camping or mobile homes. In addition, the power can also be reduced by way of software. Equally conceivable is power reduction by a changed fitting-out of the circuitboards.

The AC side—load side—is in that case always part of the inverter. An AC input or a bidirectional interface to current mains can thereagainst be formed as an optional module. A mains monitoring system and a mains isolation circuit can equally be provided as an optional module.

Moreover, a further DC/DC converter which is provided as a step-down device and is preferably equipped with a maximum power point tracker for photovoltaic modules can also be incorporated in the energy system. The possibility is thus created of charging a first energy store with a high photovoltaic voltage with a low transformation ratio or further energy stores with a higher transformation ratio.

In other applications, primarily in the field of caravans and mobile homes, the inclusion of a photovoltaic module within protective low voltage in the current circuit of the second energy store can also be made possible. No transformation or only a small transformation is then necessary here.

According to use, the best suitable connection point for an energy source, particularly a photovoltaic system, can be selected.

The present invention provides at least one electrically coupled converter which with a low transformation ratio makes available from a DC voltage, which preferably lies at 20 to 100% of the effective value of the AC voltage, an AC voltage from a battery store. In addition, an electrically isolated DC/DC converter of lower power is preferably provided for integration in a further voltage plane with an overall greater transformation ratio, at which, for example, starter batteries, redox flow batteries or fuel cells can be integrated.

An energy system according to the invention is, for example, illustrated in FIG. 1. There four LiFePO4 battery packs, which designated by 1, each with approximately 50 volts are connected in series, which yields a system voltage of about 200 volts. Each individual battery module/battery pack lies within protective low voltage. All battery packs 1 are each equipped with an electrically isolated DC/DC converter 2. The outputs of the DC/DC converter are connected in parallel with one another, whereby an energy exchange (balancing) between the battery packs 1 can be effected with a low transformation ratio in the DC/DC converters 2. In addition, an on-board mains battery 3 with 12 volts or 24 volts is connected with the DC/DC converters 2. An energy exchange with a low transformation voltage can also take place with this.

A balancing between the individual battery packs 1 can now take place by way of the DC/DC converters 2. In addition, the on-board mains battery 3 can be charged. If the on-board mains battery 3 is charged externally, for example by a generator/alternator (not illustrated), energy can be transferred by the on-board mains from the on-board mains battery 3 to the battery packs 1.

The DC/DC converters 2 are constructed to be electrically isolated.

The battery packs 1 connected in series form a voltage which can be converted by a small transformation ratio in an inverter or DC/AC converter 6 into an alternating voltage. An alternating voltage with 230 volts is generated here.

Several switched AC terminals 7 can be provided at the DC/AC converter 6 and enable a synchronisation and separation of further AC mains or a prioritised load switching. In addition, it is also conceivable in the case of bidirectional realisation of the DC/AC converter 6 for energy to be fed into the battery packs 1 by way of that.

It is possible by way of a further DC/DC converter 5, which can also be realised as a photovoltaic charging regulator, to efficiently incorporate further energy sources such as, for example, photovoltaic modules 4 as well as energy converters such as fuel cells or energy stores on a higher voltage plane.

In this embodiment the inverter 6 is designed for four kilowatt power, so that fuse protection at 20 amps, matching usual fuse protection, is possible.

The components on the DC side are here also usually designed to 20 amps. The maximum power point tracking charge regulator 5 is designed for ten photovoltaic modules with 330 watts-peak and thus for an approximate maximum voltage of about 450 volts on the photovoltaic side with about 10 amps current. This is converted to the 200 volt battery voltage.

If more power is needed, several inverters can be connected together.

The individual systems are closed in themselves, but nevertheless modular.

All converters operate with a small transformation ratio so that these operate very efficiently.

Protective standards even in the field of caravans are fulfilled without problem, since only 12 volts or 24 volts DC with electrical isolation are led out of the system.

In FIG. 2 there is a circuit of a DC/AC converter 6 in which a sine wave can be formed from a DC source 1 by only a single coil, whilst the negative pole of the DC side has the same potential as the neutral conductor of the AC side. A plurality of switches is provided. The switches can in that case be embodied as semiconductors, above all MOSFETs, even with MOSFETs arranged in pairs for bidirectional use. The use of GaN or SiC MOSFETs with high clock rates is also possible.

In FIG. 3 there is schematically a circuit of a DC/AC converter 6 in which the common potential at the centre of the battery pack 1 is connected with the neutral conductor of the AC side. In each instance a converter is responsible for generating a half wave. An electrically isolated DC/DC converter 2, which is connected with further battery systems 3, can also be arranged in this circuit at each of the battery packs 1. The combination with other DC/DC converters and a three-phase embodiment is also possible.

FIG. 4 schematically shows a sine wave which is superimposed from a clocked part and a non-clocked part, which corresponds with the battery voltage. It can also be seen from this how in the case of a short-circuit, by contrast to a sine wave produced from 400 volts, a high short-circuit current can be more simply provided directly from the battery without, in the case of switching-off on the load side, having to take into account an excess voltage when switching-off occurs.

In FIG. 5 there is schematically shown a circuit of a DC/AC converter which can be produced particularly simply and favourably. However, here there is no common potential between DC terminal and AC terminal. This converter is thus particularly suitable as an additional converter, which, for example, by way of an already electrically isolated DC terminal can provide a sine signal at low power for standby operation.

1. An energy system with at least one energy store for storage of electrical energy and at least one inverter, wherein the energy system is of modular construction with respect to energy stores and/or inverters.

2. The energy system according to claim 1, wherein at least one battery store with at least one battery module is provided, wherein the individual battery modules are designed within the scope of protective low voltage.

3. The energy system according to claim 1, wherein the battery modules of a battery store are connected in series and/or in parallel with one another.

4. The energy system according to claim 1, wherein charge equalization of the individual battery modules of a battery store is provided.

5. The energy system according to claim 1, wherein a DC/DC converter is provided for each battery store or each battery module and can be executed to be electrically isolated.

6. The energy system according to claim 1, wherein a DC/DC converter is provided, which generates a first system voltage which can be higher or lower than or the same as the voltage of individual or multiple battery modules, wherein the DC/DC converter can have electrical isolation and be executed to be bidirectional.

7. The energy system according to claim 1, wherein a DC/AC converter is provided, which can be executed to be bidirectional.

8. The energy system according to claim 1, wherein a plurality of DC/AC and/or DC/DC converters is provided.

9. The energy system according to claim 1, wherein the respective converter or the respective converter combination is selected according to the operating state of the energy system, wherein that converter or converter combination having the lowest losses can be selected.

10. The energy system according to claim 1, wherein a power limitation is provided according to the respective operating state of the energy system.

11. The energy system according to claim 9, wherein the system is designed so that provided protective devices are preferably selectively triggered.

12. The energy system according to claim 1, wherein an efficient electronic charging system for charging the battery store is provided, wherein this can also be designed as a simple rectifier circuit with appropriate adjustment of the voltage of the battery store.

13. The energy system according to claim 1, wherein the energy system combines different energy sources on AC and/or DC side and/or different energy stores, in particular battery stores with modules of lithium batteries, preferably LiFePO4 batteries, lead batteries, oxidation-reduction flow batteries or other store types.

14. The energy system according to claim 13, wherein the converter modules for each energy source or each energy store are designed, with regard to the characteristics thereof, with respect to, for example, power.

15. The energy system according to claim 1, wherein the energy sources are electrically isolated by way of the DC/DC converter.

16. The energy system according to claim 1, wherein an energy distribution between the individual energy sources or energy stores is provided by way of the DC circuit.

17. The energy system according to claim 1, wherein the DC circuit is so designed with respect to its voltage that the DC/AC converter has only a small transformation ratio with respect to the voltage or does not undertake any voltage transformation and only has to form the alternating voltage.

18. The energy system according to claim 1, wherein the DC converter has only a small transformation ratio with respect to the voltage.

19. The energy system according to claim 1, wherein the circuits of the converters are so constructed that the negative poles of the rectifier systems correspond with the neutral conductor of the alternating voltage systems and thus a common reference potential is present.

20. The energy system according to claim 1, wherein two or more storage systems are arranged antisymmetrically and each of the two storage systems has an associated DC/AC converter which respectively generates a half wave of the alternating voltage and that the neutral conductor of the alternating voltage system has a common reference potential with the center of the storage modules.

21. The energy system according to claim 1, wherein storage systems with different characteristics, particularly long-term storage systems and short-term storage systems, are combined with one another, wherein it can be provided that only the AC terminals and the DC terminals, which are electrically isolated by the DC/DC converter, can be tapped without making available direct access to the storage modules.

22. The energy system according to claim 1, wherein several autonomous energy systems are combined at least temporarily to form an overall system, wherein the energy systems can also be arranged to be physically separate.

23. The energy system according to claim 1, wherein a control unit for each energy system or also in superordinate form for a plurality of energy systems is provided.

24-25. (canceled)
